(19) United States
(12) Patent Application Publication
(10) Pub. No.: US 2009/0288538 A1
(43) Pub. Date: Nov. 26, 2009

(54) Knife Carrier Having Variably Adjustable Preload of the Circular Knife

(76) Inventors: Rudolf Supe-Dienes, Overath (DE); Falk Oberhaff, Reichshaf (DE)

Correspondence Address: ROBERT W. BECKER & ASSOCIATES, 707 HIGHWAY 333, SUITE B, TIJERAS, NM, 87059-7507, US

(21) Appl. No.: 12/468,805

(22) Filed: May 19, 2009

(30) Foreign Application Priority Data
May 20, 2008 (DE) 10 2008 024 362.0

(51) Int. Cl. B26D 1/18

(52) U.S. Cl. 83/483

(57) ABSTRACT

A longitudinal cutting or slitting machine having a knife carrier that supports a circular knife. A pre-tensioning element is disposed on the knife carrier for preloading the circular knife into a cutting position defined by abutment of the circular knife against a counterknife. An adjustment mechanism is disposed on the knife carrier for effecting a variable adjustment of a preloading force exerted by the pre-tensioning element onto the circular knife.

The instant application should be granted the priority date of May 20, 2008 the filing date of the corresponding German patent application 10 2008 024 362.0.

### BACKGROUND OF THE INVENTION

The present invention relates to a longitudinal cutting or slitting machine having disposed thereon knife carriers for a circular knife respectively held thereon, whereby the circular knife is pre-tensioned or preloaded by a pre-tensioning element disposed on the knife carrier into its cutting position defined by abutment of the circular knife against a counterknife.

A knife carrier provided for a longitudinal cutting or slitting machine and having the aforementioned features is known from DE 202 01 744 U1. With the blade holder described in this document, the circular knife, which is mounted on a hub formed on the knife carrier, is pre-tensioned by a knife spring to rest against the counterknife, whereby the knife spring is comprised of two leaf springs that are placed against one another, are inserted on the hub, and are supported against the knife carrier.

To the extent that with a knife carrier embodied in this fashion the circular knife can respectively deflect against the effect of the knife spring, it can be expedient to configure the pre-tensioning or preloading force, or the spring force, proceeding from the knife spring to be adjustable, since in this way it is possible to establish different cutting forces between the counterknife and the circular knife.

It is therefore an object of the present invention to provide a longitudinal cutting or slitting machine having the aforementioned knife carrier in such a way that a variable setting of the preloading force proceeding from the pre-tensioning element is possible.

### BRIEF DESCRIPTION OF THE DRAWINGS

This object, and other objects and advantages of the present invention, will appear more clearly from the following specification in conjunction with the accompanying schematic drawing, in which:

FIG. 1 is a side view showing a portion of a knife carrier with a circular knife held thereon and with a pre-tensioning element embodied as a knife spring, with the least possible set spring force of the knife spring,

FIG. 2 shows the subject matter of FIG. 1 with the knife spring deactivated,

FIG. 3 shows an embodiment of the knife carrier with a pre-tensioning element embodied as a pressure distribution ring having a pre-tensioning force that can be set, and,

FIG. 4 shows the subject matter of FIG. 3 with the circular knife fixed in position in a non-displaceable manner.

### SUMMARY OF THE INVENTION

The basic concept of the present invention is that the pre-tensioning or preloading force that is exerted by the pre-tensioning element onto the circular knife can be variably adjusted by means of an adjustment mechanism that is disposed on the knife carrier.

In certain operating states it can be desirable, beyond the variably adjustable preloading force, to dispose the circular knife on the knife carrier in a fixed position and to thus fix it in a non-displaceable manner against the counterknife. Such a knife carrier is described, for example, in EP 0 113 668 A1, according to which the circular knife is fixedly clamped against the knife carrier. Thus, pursuant to one embodiment of the invention, the adjustment mechanism is configured to set the preload force such as to make the pre-tensioning element without effect, resulting in a fixed connection between the knife carrier and the circular knife.

Pursuant to a first embodiment of the invention, the pre-tensioning element is embodied as a knife spring that is supported on the knife carrier and that preloads the circular knife into its cutting position.

A variable adjustment of the respectively acting spring force of the knife spring, up to its entire deactivation, can be realized pursuant to an embodiment of the invention if the circular knife is mounted on a hub formed on the knife carrier and is secured by means of an annular nut disposed on the hub, whereby the adjustment mechanism is integrated into the annular nut. In particular, the annular nut can be divided by a plane of separation into two annular nut sections that are movable relative to one another in such a way that a rotation of the annular nut sections relative to one another brings about an axial displacement of one of the annular nut sections along with an axial enlargement of the width of the annular nut. By means of this alteration of the axial overall width of the annular nut, an adjustment of the spring force proceeding from the knife spring is ultimately possible.

Pursuant to embodiments of the invention, for this purpose the plane of separation formed on the annular nut can be configured as an inclined plane that extends in the axial direction between the annular nut sections. Alternatively, the plane of separation that is formed on the annular nut can be configured with a contour that is wave shaped in the peripheral direction and in the axial direction of the annular nut forms wave peaks and wave troughs. In both cases, when the annular nut sections rotate relative to one another, the two annular nut sections run against one another along their plane of separation, leading to the axial displacement of one of the two sections.

With regard to the configuration of the knife spring, pursuant to one embodiment of the invention the knife spring is embodied as a set of springs that includes at least two leaf springs that are placed against one another and are disposed on a hub, and that is disposed between the annular nut and the circular knife, whereby the pre-tensioning force of the set of springs can be variably adjustable by axial displacement of the annular nut sections.

Alternatively, for the configuration of the pre-tensioning element as a mechanically operating spring, pursuant to an embodiment of the invention the pre-tensioning element is embodied as a pressure distribution ring that is disposed on a knife carrier and has a plurality of axially movable pistons that are distributed over its periphery and are intended for abutment against the circular knife; the pistons are connected to a uniform pressure chamber for a fluid that is to be introduced therein. Such a pressure distribution ring is known, for example, from DE 10232772 B3.

If the pressure of the fluid present in the pressure chamber of the pressure distribution ring is variably adjustable by means of the associated adjustment mechanism, then on the one hand the pressure in the pressure chamber of the pressure distribution ring can be set to such a value that during the cutting operation a circular knife that deflects against the action of the pistons presses the pistons into the pressure distribution ring until the pressure set in the pressure chamber is reached. If the pressure in the pressure chamber in the pressure distribution ring is set so high that a pressing-in of the pistons by the circular knife is no longer possible, the manner of operation is configured for a circular knife that is fixed in position.

Pursuant to a modified embodiment, the pre-tensioning element can be embodied as an inflatable hose that is disposed on the knife carrier and that is supported between the circular knife and an abutment disposed on the knife carrier. In this connection, the support against the circular knife can be realized directly by abutment of the hose against the circular knife, or indirectly via the interposition of a suitable component. Also with this embodiment it is possible, by regulating the inflation hardness of the hose, to set the pressure in the hose in such a way that on the one hand during the cutting operation the circular knife deflects to the desired extent, and on the other hand the circular knife is fixed in position by a hose that is inflated to an appropriately hard extent.

It is possible to employ the present invention with all types of knife carriers, and in particular with a knife carrier that is part of a knife head provided on a knife holder disposed on the longitudinal cutting or slitting machine, or, alternatively, with a knife carrier that is a jacket or box disposed on the longitudinal cutting or slitting machine. However, the aforementioned examples of application do not limit the realization of the invention in a technical regard.

Further specific features of the present application will be described in detail subsequently.

### DESCRIPTION OF SPECIFIC EMBODIMENTS

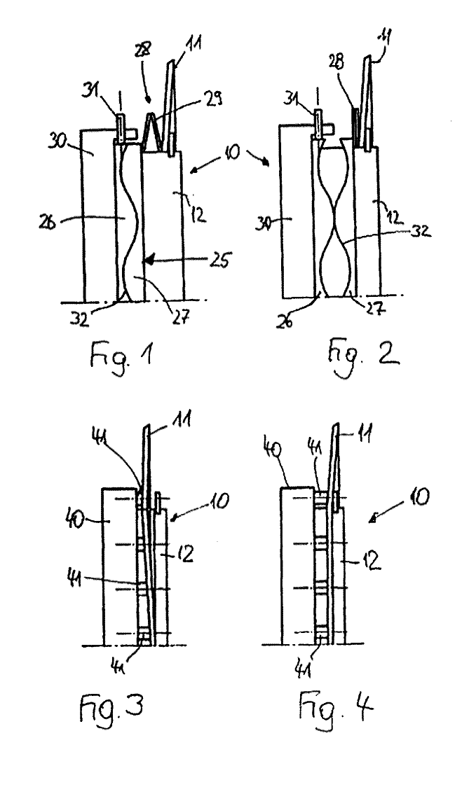

Referring now to the drawing in detail, with the embodiment illustrated in FIGS. 1 and 2, the circular knife or blade 11 that is disposed on the hub 12 of a knife carrier 10 is pre-tensioned or preloaded by a set of springs 28 that is placed on the hub 12 and is comprised of two leaf or flat springs 29, as knife springs, that are placed against one another, whereby the set of springs 28 is supported between the circular knife 11 and an annular nut 25 that is threaded onto the hub 12. By means of a plane of separation 32, the annular nut 25 is divided into two annular nut sections 26 and 27, which are displaceable relative to one another as can be seen from a comparison of FIGS. 1 and 2. The plane of separation 32 has a wave-like configuration with wave peaks and wave troughs formed in the axial direction of the annular nut 25, so that a rotation of the two annular nut sections 26, 27 relative to one another results in a running up of the wave peaks on one another, as a consequence of which the overall axial width of the annular nut 25 increases. As can be seen from FIG. 2, with the maximum spreading of the two annular nut sections 26 and 27 relative to one another, the set of springs 28 is tensioned to a block form, and in this position a deflection of the circular knife 11 is no longer possible. Thus, the manner of operation with a fixedly held circular knife is provided. It is to be understood that in the intermediate positions between the operating states illustrated in FIGS. 1 and 2, respectively different pre-tensioning of the set of springs 28 is established. For this purpose, the annular nut section 27 is provided with a handle extension 31 for the rotation of these annular nut sections. For the rotation, the annular nut section 26 is supported against an abutment 40 that is formed on the knife carrier 10.

With the embodiment illustrated in FIGS. 3 and 4, again a variable adjustment of the pre-tensioning force exerted by the pre-tensioning element is possible. For this purpose, disposed on the knife carrier 10 is a pressure distribution ring 40 in which is formed a pressure chamber for a fluid that is to be introduced therein. Connected to this pressure chamber are a plurality of axially movable pistons 41 that are distributed over the periphery of the pressure distribution ring 40; the pistons 41 are configured for resting against the circular knife 11. As can be seen from FIG. 3, the pressure in the pressure chamber of the pressure distribution ring 40 can be adjusted such that in a cutting operation, a deflection of the circular knife 11 is possible in that the circular knife presses against the pistons 41 that act upon it more or less until the pressure established in the pressure chamber in the pressure distribution ring 40 is reached. If the pressure in the pressure chamber of the pressure distribution ring 40 is set so high that a pressing-in of the pistons 41 by the force exerted by the circular knife 11 is no longer possible, then in conformity with the illustration of FIG. 4 the circular knife 11 is unmovably fixed in position by the pistons 41 so that the pre-tensioning element in the form of the pressure distribution ring 40 is without effect.

The features of the subject matter disclosed in the preceding specification, the claims, the abstract and the drawings can be important individually as well as in any desired combination with one another for realizing the various embodiments of the invention.

The specification incorporates by reference the disclosure of German priority document 10 2008 024 362.0 filed May 20, 2008.

The present invention is, of course, in no way restricted to the specific disclosure of the specification and drawings, but also encompasses any modifications within the scope of the appended claims.

What I claim is:

1. A longitudinal cutting or slitting machine, comprising:
a knife carrier that supports a circular knife;
a pre-tensioning element disposed on said knife carrier for pre-loading said circular knife into a cutting position defined by abutment of said circular knife against a counterknife; and
an adjustment mechanism disposed on said knife carrier for effecting a variable adjustment of a preloading force exerted by said pre-tensioning element onto said circular knife.

2. A longitudinal cutting or slitting machine according to claim 1, wherein said adjustment mechanism is configured to set said preloading force such as to make said pre-tensioning element without effect, resulting in a fixed connection between said knife carrier and said circular knife.

3. A longitudinal cutting or slitting machine according to claim 1, wherein said pre-tensioning element is embodied as a knife spring that is supported on said knife carrier, and that preloads said circular knife into a cutting position thereof.

4. A longitudinal cutting or slitting machine according to claim 3, wherein a hub is formed on said knife carrier, wherein an annular nut is disposed on said hub, wherein said circular knife is mounted on said hub, and is secured via said annular nut, and wherein said adjustment mechanism is integrated into said annular nut.

5. A longitudinal cutting or slitting machine according to claim 4, wherein said annular nut is divided by a plane of separation into two annular nut sections that are movable relative to one another such that a rotation of said annular nut sections relative to one another brings about an axial displacement of one of said annular nut sections along with an axial enlargement of a width of said annular nut.

6. A longitudinal cutting or slitting machine according to claim 5, wherein said plane of separation formed on said annular nut is configured as an inclined plane that extends in a generally axial direction between said annular nut sections.

7. A longitudinal cutting or slitting machine according to claim 5, wherein said plane of separation formed on said annular nut is configured with a contour that is wave-shaped in a peripheral direction and in an axial direction of said annular nut forms wave peaks and wave troughs.

8. A longitudinal cutting or slitting machine according to claim 4, wherein said knife spring is embodied as a set of springs that includes at least two leaf springs disposed on said hub and placed against one another, wherein said set of springs is disposed between said annular nut and said circular knife.

9. A longitudinal cutting or slitting machine according to claim 8, wherein a pre-tensioning force of said set of springs is variably adjustable by axial displacement of at least one of said annular nut sections.

10. A longitudinal cutting or slitting machine according to claim 1, wherein said pre-tensioning element is embodied as a pressure distribution ring that is disposed on said knife carrier, wherein said pressure distribution ring is provided with a plurality of axially movable pistons distributed over the periphery of said pressure distribution ring for abutment against said circular knife, and wherein said pistons are connected to a uniform pressure chamber for a fluid that is adapted to be introduced therein.

11. A longitudinal cutting or slitting machine according to claim 10, wherein fluid pressure present in said pressure chamber of said pressure distribution ring is variably adjustable by means of said adjustment mechanism.

12. A longitudinal cutting or slitting machine according to claim 1, wherein said pre-tensioning element is embodied as an inflatable hose that is disposed on said knife carrier, and wherein said inflatable hose is supported between said circular knife and an abutment disposed on said knife carrier.

13. A longitudinal cutting or slitting machine according to claim 1, wherein said knife carrier is part of a knife head provided on a knife holder disposed on said longitudinal cutting or slitting machine.

14. A longitudinal cutting or slitting machine according to claim 1, wherein said knife carrier is a jacket or box disposed on said longitudinal cutting or slitting machine.
